(19) United States
(12) Patent Application Publication
(10) Pub. No.: US 2016/0364366 A1
(43) Pub. Date: Dec. 15, 2016

(54) Entity Matching Method and Apparatus

(71) Applicant: Huawei Technologies Co., Ltd., Shenzhen (CN)

(72) Inventors: Liang Lan, Shenzhen (CN); Mingxuan Yuan, Hong Kong (HK); Jia Zeng, Hong Kong (HK)

(21) Appl. No.: 15/245,795

(22) Filed: Aug. 24, 2016

Related U.S. Application Data
(63) Continuation of application No. PCT/CN2015/072607, filed on Feb. 10, 2015.

(30) Foreign Application Priority Data
Feb. 28, 2014 (CN) 201410072492.5

(51) Int. Cl. G06F 17/16; G06F 17/11

(52) U.S. Cl. CPC G06F 17/16; G06F 17/11

(57) ABSTRACT

An entity matching method and apparatus, where the method includes, calculating kernel matrices K and L after reading a first data source and a second data source with inconsistent entity quantities, respectively, solving a first optimization objective function to obtain a matrix M of a correspondence between an entity on the first data source and an entity on the second data source, and outputting the obtained matrix M. Hence, according to the entity matching method and apparatus provided in the present disclosure, entity matching when entity quantities of data sources are inconsistent may be performed such that accuracy of data mining may be effectively improved, and data value may be effectively presented.

### CROSS-REFERENCE TO RELATED APPLICATIONS

This application is a continuation application of international application number PCT/CN2015/072607 filed on Feb. 10, 2015, which claims priority to Chinese patent application number 201410072492.5 filed on Feb. 28, 2014, both of which are incorporated by reference.

### TECHNICAL FIELD

Embodiments of the present disclosure relate to the field of communications technologies, and in particular, to an entity matching method and apparatus.

### BACKGROUND

In a background of big data, behavioral data of users on different data sources may be collected using various services, for example, behavior track data of the users in a real world may be obtained using a mobile broadband data source of an operator, information about applications downloaded and installed by the users may be obtained using an application market data source, and other various types of data (for example, microblog data and Renren.com data) of the users may also be easily obtained using various types of common application programming interfaces (APIs). In a current situation, all these data sources are independent of each other, and different data sources respectively describe behavior information of the users in different dimensions. The users can be understood more clearly and accurately if all these data sources can be associated, and a function and a value of the data can be brought into full play.

Currently, an implementation method for associating different data sources is to perform entity matching between the different data sources. A conventional kernelized sorting (N. Quadrianto et al., 2010) method can be used to perform entity matching in a case in which similarity between data records on the different data sources cannot be directly calculated. In this method, first, on different data sources, kernel matrices of the data sources are calculated, where entity (user) quantities on the different data sources are consistent, and then entity matching is performed by maximizing correlations between the kernel matrices on the different data sources. Another convex kernelized sorting (N. Djuric et al., 2012) method is an extension of the kernelized sorting method. Convex kernelized sorting can ensure that a global optimal solution can be found. In addition, in a solving process, some common software packages for solving convex optimization problems may be used for implementation such that an effect is more stable and accurate than that of kernel sorting.

However, both the foregoing two methods require that the entity quantities of the different data sources to be consistent. In processing of an actual problem, entity matching between the data sources cannot be performed using the foregoing methods when entity quantities of two data sources are inconsistent.

### SUMMARY

Embodiments of the present disclosure provide an entity matching method and apparatus, which can perform entity matching when entity quantities of data sources are inconsistent such that accuracy of data mining can be effectively improved.

According to a first aspect, an embodiment of the present disclosure provides an entity matching method, including calculating an m₁×m₁ kernel matrix K on the first data source after reading a first data source and a second data source, and calculating an m₂×m₂ kernel matrix L on the second data source, where entity quantities of the first data source and the second data source are respectively m₁ and m₂, solving a first optimization objective function to obtain a matrix M of a correspondence between an entity on the first data source and an entity on the second data source, where the first optimization objective function is as follows:

$${min}_{M} {‖ {KM}^{T} - {( LM )}^{T} ‖}^{2}$$

$$s . t {M}_{ij} ∈ \{ 0 , 1 ) ∀ i , j$$

$${M}^{T} {1}_{{m}_{2}} \leq {1}_{{m}_{1}}$$

$$M {1}_{{m}_{1}} \leq {1}_{{m}_{2}}$$

$${( {1}_{{m}_{2}} )}^{T} M {1}_{{m}_{1}} = min ( {m}_{1} , {m}_{2} ) ,$$

where the matrix M is an m₂×m₁ matrix, Mᵢⱼ=1 indicates that the j^{th} entity on the first data source matches the i^{th} entity on the second data source, and Mᵢⱼ=0 indicates that the j^{th} entity on the first data source does not match the i^{th} entity on the second data source, and outputting the obtained matrix M.

In a first possible implementation manner of the first aspect, the first optimization objective function is:

$${min}_{M} {‖ {KM}^{T} - {( LM )}^{T} ‖}^{2}$$

$$s . t {M}_{ij} \geq 0 ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) ,$$

and solving a first optimization objective function includes solving the first optimization objective function using a convex optimization software package.

With reference to the first aspect or the first possible implementation manner of the first aspect, in a second possible implementation manner of the first aspect, before solving a first optimization objective function, the method further includes performing entity matching between the entity on the first data source and the entity on the second data source according to unique identifiers of the entities, solving the first optimization objective function when there is no matched entity, and using the existent matched entities to form an m₂×m₁ matrix A when there are matched entities, where Aᵢⱼ=1 when the j^{th} entity on the first data source matches the i^{th} entity on the second data source, and Aᵢⱼ=0 when the j^{th} entity on the first data source does not match the i^{th} entity on the second data source, and solving a second optimization objective function to obtain the matrix M of the correspondence between the entity on the first data source and the entity on the second data source, where the second optimization objective function is as follows:

$${min}_{M} {‖ {KM}^{T} - {( LM )}^{T} ‖}^{2} + λ {‖ MH - A ‖}^{2}$$

$$s . t {M}_{ij} ∈ \{ 0 , 1 ) ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) ,$$

where H is an m₁×m₁ matrix, and Hᵢᵢ=1 when the i^{th} entity on the first data source is an entity that may be matched according to the unique identifier, or Hᵢᵢ=0 when the i^{th} entity on the first data source is not an entity that may be matched according to the unique identifier, where λ is a predefined scalar.

With reference to the second possible implementation manner of the first aspect, in a third possible implementation manner of the first aspect, the second optimization objective function is:

$${min}_{M} {‖ {KM}^{T} - {( LM )}^{T} ‖}^{2} + λ {‖ MH - A ‖}^{2}$$

$$s . t {M}_{ij} \geq 0 ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) ,$$

and solving a second optimization objective function includes solving the second optimization objective function using a convex optimization software package.

With reference to the first aspect or any one of the first to third possible implementation manners of the first aspect, in a fourth possible implementation manner of the first aspect, outputting the obtained matrix M includes sorting values of entities in each column of the matrix M in descending order, and outputting N entities with a maximum Mᵢⱼ value in each column, or setting a value corresponding to a maximum value in each column of the matrix M to 1, setting a value corresponding to another value except the maximum value in each column to 0, and outputting a matching result.

According to a second aspect, an embodiment of the present disclosure provides an entity matching apparatus, including a calculating module configured to calculate an m₁×m₁ kernel matrix K on the first data source, and calculate an m₂×m₂ kernel matrix L on the second data source after a first data source and a second data source are read, where entity quantities of the first data source and the second data source are respectively m₁ and m₂. A first processing module configured to solve a first optimization objective function to obtain a matrix M of a correspondence between an entity on the first data source and an entity on the second data source, where the first optimization objective function is as follows:

$${min}_{M} {‖ {KM}^{T} - {( LM )}^{T} ‖}^{2}$$

$$s . t {M}_{ij} ∈ \{ 0 , 1 ) ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) ,$$

where the matrix M is an m₂×m₁ matrix, Mᵢⱼ=1 indicates that the j^{th} entity on the first data source matches the i^{th} entity on the second data source, and Mᵢⱼ=0 indicates that the j^{th} entity on the first data source does not match the i^{th} entity on the second data source, and an outputting module configured to output the obtained matrix M.

In a first possible implementation manner of the second aspect, the first optimization objective function is:

$${min}_{M} {‖ {KM}^{T} - {( LM )}^{T} ‖}^{2}$$

$$s . t {M}_{ij} \geq 0 ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) ,$$

and the first processing module solves the first optimization objective function which includes solving the first optimization objective function using a convex optimization software package.

With reference to the second aspect or the first possible implementation manner of the second aspect, in a second possible implementation manner of the second aspect, the apparatus further includes a matching module configured to perform entity matching between the entity on the first data source and the entity on the second data source according to unique identifiers of the entities before the first processing module solves the first optimization objective function, where the first processing module solves the first optimization objective function when there is no matched entity, and a second processing module configured to use the existent matched entities to form an m₂×m₁ matrix A when there are matched entities, where Aᵢⱼ=1 when the j^{th} entity on the first data source matches the i^{th} entity on the second data source, and Aᵢⱼ=0 when the j^{th} entity on the first data source does not match the i^{th} entity on the second data source, and solve a second optimization objective function to obtain the matrix M of the correspondence between the entity on the first data source and the entity on the second data source, where the second optimization objective function is as follows:

$${min}_{M} {‖ {KM}^{T} - {( LM )}^{T} ‖}^{2} + λ {‖ MH - A ‖}^{2}$$

$$s . t {M}_{ij} ∈ \{ 0 , 1 ) ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) ,$$

where H is an m₁×m₁ matrix, and Hᵢᵢ=1 when the i^{th} entity on the first data source is an entity that may be matched according to the unique identifier, or Hᵢᵢ=0 when the i^{th} entity on the first data source is not an entity that may be matched according to the unique identifier, where λ is a predefined scalar.

With reference to the second possible implementation manner of the second aspect, in a third possible implementation manner of the second aspect, the second optimization objective function is:

$${min}_{M} {‖ {KM}^{T} - {( LM )}^{T} ‖}^{2} + λ {‖ MH - A ‖}^{2}$$

$$s . t {M}_{ij} \geq 0 ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) ,$$

and the second processing module solves the second optimization objective function which includes solving the second optimization objective function using a convex optimization software package.

With reference to the second aspect or any one of the first to third possible implementation manners of the second aspect, in a fourth possible implementation manner of the second aspect, the outputting module outputs the obtained matrix M which includes sorting values of entities in each column of the matrix M in descending order, and outputting N entities with a maximum Mᵢⱼ value in each column, or setting a value corresponding to a maximum value in each column of the matrix M to 1, setting a value corresponding to another value except the maximum value in each column to 0, and outputting a matching result.

According to the entity matching method provided in embodiments of the present disclosure, after a first data source and a second data source with inconsistent entity quantities are read, kernel matrices K and L are respectively calculated. Then a first optimization objective function is solved to obtain a matrix M of a correspondence between an entity on the first data source and an entity on the second data source, and finally, the obtained matrix M is output. Therefore, entity matching when entity quantities of data sources are inconsistent can be performed such that accuracy of data mining can be effectively improved, and data value can be effectively presented.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show some embodiments of the present disclosure, and persons of ordinary skill in the art may still derive other drawings from these accompanying drawings without creative efforts.

FIG. 1 is a flowchart of Embodiment 1 of an entity matching method according to the present disclosure;

FIG. 2 is a flowchart of Embodiment 2 of an entity matching method according to the present disclosure;

FIG. 3 is a schematic structural diagram of Embodiment 1 of an entity matching apparatus according to the present disclosure; and

FIG. 4 is a schematic structural diagram of Embodiment 2 of an entity matching apparatus according to the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

According to an entity matching method and apparatus provided in embodiments of the present disclosure, a problem of performing entity matching in a case in which similarity between data records on different data sources cannot be directly calculated can be resolved, and entity matching when entity quantities of the data sources are inconsistent can be performed. In addition, precious sample annotation information may also be effectively used to improve accuracy of entity matching. The method in the embodiments of the present disclosure may be extensively applied in a system integrating heterogeneous data sources. The entity matching method and apparatus provided in the embodiments of the present disclosure are hereinafter described in detail with reference to the accompanying drawings.

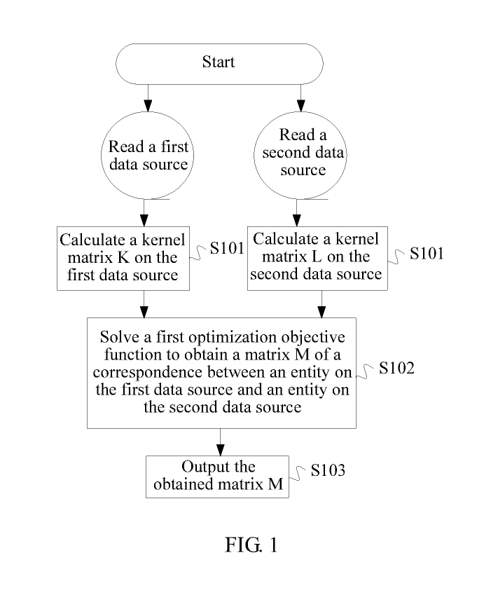

FIG. 1 is a flowchart of Embodiment 1 of an entity matching method according to the present disclosure. As shown in FIG. 1, the method in this embodiment may include the following steps.

Step S101: After reading a first data source and a second data source, calculate an m₁×m₁ kernel matrix K on the first data source, and calculate an m₂×m₂ kernel matrix L on the second data source, where entity quantities of the first data source and the second data source are respectively m₁ and m₂.

Furthermore, in implementation of reading the first data source and the second data source, for example, data input is implemented by reading a text using a keyboard. The entity quantities of the first data source and the second data source are respectively m₁ and m₂. For example, the first data source is X={x₁, x₂, . . . , xₘ₁}, and the second data source is Y={y₁, y₂, . . . , yₘ₂}. The m₁×m₁ kernel matrix K is calculated on the first data source after the first data source and the second data source are read, where the (i, j)^{t1} element Kᵢⱼ in the kernel matrix K indicates similarity between xᵢ and xⱼ in reproducing kernel Hilbert space. Likewise, the m₂×m₂ kernel matrix L is calculated on the second data source.

An objective of entity matching is to find a one-to-one correspondence between an entity on the first data source and an entity on the second data source. Such a one-to-one correspondence between different data sources may be indicated using an m₂×m₁ permutation matrix M, where Mᵢⱼ=1 indicates that the j^{th} entity on the first data source matches the i^{th} entity on the second data source, and Mᵢⱼ=0 indicates that the j^{th} entity on the first data source does not match the i^{th} entity on the second data source. To find the one-to-one correspondence between the entity on the first data source and the entity on the second data source, it is required to find an optimal permutation matrix M to rearrange rows in the kernel matrix K and rearrange columns in the kernel matrix L such that two rearranged kernel matrices have a highest correlation. This process may also be expressed, in a mathematical form, as an optimization problem shown in the following first objective function.

Step S102: Solve a first optimization objective function to obtain a matrix M of a correspondence between an entity on the first data source and an entity on the second data source, where the first optimization objective function is as follows:

$${min}_{M} {‖ {KM}^{T} - {( LM )}^{T} ‖}^{2}$$

$$s . t {M}_{ij} ∈ \{ 0 , 1 ) ∀ i , j$$

$${M}^{T} {1}_{{m}_{2}} \leq {1}_{{m}_{1}}$$

$$M {1}_{{m}_{1}} \leq {1}_{{m}_{2}}$$

$${( {1}_{{m}_{2}} )}^{T} M {1}_{{m}_{1}} = min ( {m}_{1} , {m}_{2} ) .$$

The matrix M is an m₂×m₁ matrix. It should be noted that the kernel matrices K and L have already been standardized using K=EKE and L=ELE, where E=I−1/m. A problem to be solved is a binary integer programming problem, and a process of solving the first optimization objective function may be, for example, implemented using a branch and bound method, but solving based on this method is time-consuming.

To implement soft matching and simplify the foregoing optimization problem, in this embodiment of the present disclosure, a constraint that each element in the matrix M must be 0 or 1 is changed to Mᵢⱼ≧0, and therefore, the first optimization objective function is changed to:

$${min}_{M} \vert \vert {KM}^{T} - {( LM )}^{T} {\vert \vert}^{2} \\ s . t {M}_{ij} \geq 0 ∀ i , j$$

$${M}^{T} {1}_{{m}_{2}} \leq {1}_{{m}_{1}}$$

$$M {1}_{{m}_{1}} \leq {1}_{{m}_{2}}$$

$${( {1}_{{m}_{2}} )}^{T} M {1}_{{m}_{1}} = min ( {m}_{1} , {m}_{2} ) .$$

In this case, a convex optimization software package may be used to solve the first optimization objective function, and a solving process is comparatively convenient and quick.

Step S103: Output the obtained matrix M.

Furthermore, there are two implementation manners of outputting the obtained matrix M. One manner may be sorting values of entities in each column of the matrix M in descending order, and outputting N entities with a maximum Mᵢⱼ value in each column. The other manner is setting a value corresponding to a maximum value in each column of the matrix M to 1, setting a value corresponding to another value except the maximum value in each column to 0, and outputting a matching result.

In the entity matching method provided in this embodiment, after a first data source and a second data source with inconsistent entity quantities are read, kernel matrices K and L are respectively calculated. Then a first optimization objective function is solved to obtain a matrix M of a correspondence between an entity on the first data source and an entity on the second data source, and finally, the obtained matrix M is output. Therefore, entity matching when entity quantities of data sources are inconsistent can be performed such that accuracy of data mining can be effectively improved, and data value can be effectively presented.

In processing of an actual problem, generally, there may be a small part of annotated data, that is, a one-to-one correspondence between a small part of entities on two data sources is known, and this small part of annotation information is quite valuable. However, this small part of annotation information cannot be used in a conventional entity matching method. An embodiment of the present disclosure provides an entity matching method, which can effectively use precious sample annotation information to improve accuracy of entity matching. The method is hereinafter described in detail with reference to an accompanying drawing.

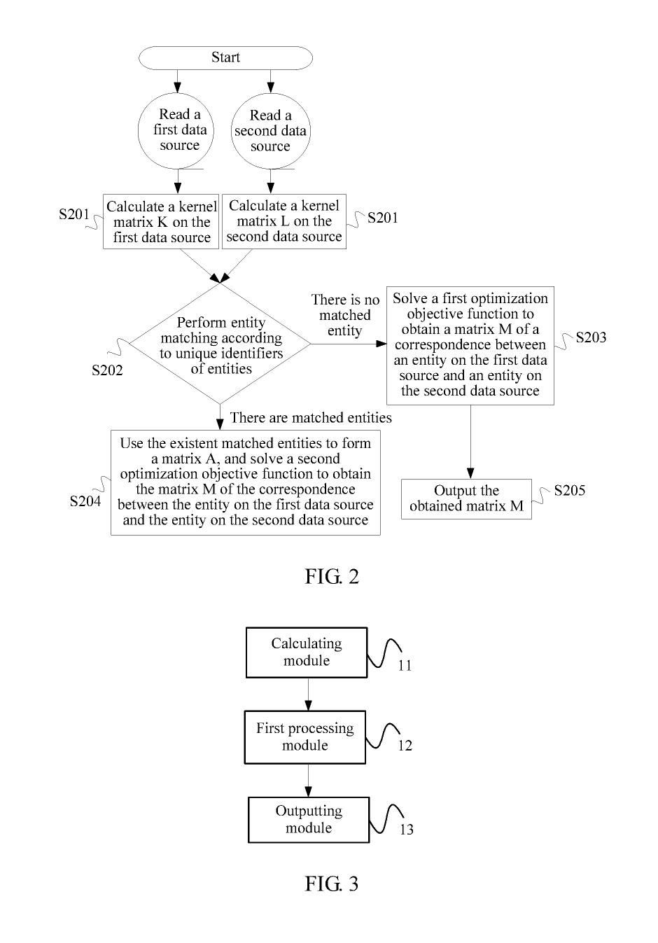

FIG. 2 is a flowchart of Embodiment 2 of an entity matching method according to the present disclosure. As shown in FIG. 2, the method in this embodiment may include the following steps.

Step S201: After reading a first data source and a second data source, calculate an m₁×m₁ kernel matrix K on the first data source, and calculate an m₂×m₂ kernel matrix L on the second data source, where entity quantities of the first data source and the second data source are respectively m₁ and m₂.

Step S202: Perform entity matching between an entity on the first data source and an entity on the second data source according to unique identifiers of the entities. Execute step S203 when there is no matched entity, and execute step S204 when there are matched entities.

Furthermore, for a small part of annotation information, simple entity matching is performed using a unique identifier of an entity, and a one-to-one correspondence between k entities on the first data source and k entities on the second data source can be known. Possibly, due to a problem of data missing or the like, a value of k herein may be very small, and perhaps in many cases, the value of k is 0. The one-to-one correspondence between the k entities on the two data sources may be indicated using an m₂×m₁ matrix A.

Step S203: Solve a first optimization objective function to obtain a matrix M of a correspondence between an entity on the first data source and an entity on the second data source.

A specific process is described in the foregoing method shown in FIG. 1, and is not repeated herein.

Step S204: Use the existent matched entities to form an m₂×m₁ matrix A, where Aᵢⱼ=1 when the j^{th} entity on the first data source matches the i^{th} entity on the second data source, and Aᵢⱼ=0 when the j^{th} entity on the first data source does not match the i^{th} entity on the second data source, and solve a second optimization objective function to obtain a matrix M of a correspondence between the entity on the first data source and the entity on the second data source, where the second optimization objective function is as follows:

$${min}_{M} \vert \vert {KM}^{T} - {( LM )}^{T} {\vert \vert}^{2} + λ \vert \vert MH - A {\vert \vert}^{2} \\ s . t {M}_{ij} ∈ \{ 0 , 1 ) ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) .$$

H is an m₁×m₁ matrix, and Hᵢᵢ=1 when the i^{th} entity on the first data source is an entity that may be matched according to the unique identifier, or Hᵢᵢ=0 when the i^{th} entity on the first data source is not an entity that may be matched according to the unique identifier, where λ is a predefined scalar, for example, λ may be 0.1, 1, or another value. It should be noted that the kernel matrices K and L have already been standardized using K=EKE and L=ELE, where E=I−1/m. A problem to be solved is a binary integer programming problem when the variable Mᵢⱼ is defined as 0 or 1, and a process of solving the first optimization objective function may be, for example, implemented using a branch and bound method, but solving based on this method is time-consuming.

To implement soft matching and simplify the foregoing optimization problem, in this embodiment of the present disclosure, a constraint that each element in the matrix M must be 0 or 1 is changed to Mᵢⱼ≧0, and therefore, the second optimization objective function is changed to:

$${min}_{M} \vert \vert {KM}^{T} - {( LM )}^{T} {\vert \vert}^{2} + λ \vert \vert MH - A {\vert \vert}^{2} \\ s . t {M}_{ij} \geq 0 ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) .$$

In this case, a convex optimization software package may be used to solve the second optimization objective function, and a solving process is comparatively convenient and quick.

Step S205: Output the obtained matrix M.

Furthermore, there are two implementation manners of outputting the obtained matrix M. One manner may be sorting values of entities in each column of the matrix M in descending order, and outputting N entities with a maximum Mᵢⱼ value in each column. The other manner is setting a value corresponding to a maximum value in each column of the matrix M to 1, setting a value corresponding to another value except the maximum value in each column to 0, and outputting a matching result.

In the entity matching method provided in this embodiment, after a first data source and a second data source with inconsistent entity quantities are read, kernel matrices K and L are respectively calculated, and then entity matching is performed between an entity on the first data source and an entity on the second data source according to unique identifiers of the entities. A first optimization objective function is solved to obtain a matrix M of a correspondence between the entity on the first data source and the entity on the second data source when there is no matched entity. The existent matched entities are used to form a matrix A when there are matched entities, and a second optimization objective function is solved to obtain the matrix M of the correspondence between the entity on the first data source and the entity on the second data source. Finally, the obtained matrix M is output. Therefore, entity matching when entity quantities of data sources are inconsistent can be performed, and precious sample annotation information may also be effectively used to improve accuracy of entity matching such that accuracy of data mining can be effectively improved, and data value can be effectively presented.

FIG. 3 is a schematic structural diagram of Embodiment 1 of an entity matching apparatus according to the present disclosure. As shown in FIG. 3, the apparatus in this embodiment may include a calculating module 11, a first processing module 12, and an outputting module 13. The calculating module 11 is configured to calculate an m₁×m₁ kernel matrix K on the first data source, and calculate an m₂×m₂ kernel matrix L on the second data source after a first data source and a second data source are read, where entity quantities of the first data source and the second data source are respectively m₁ and m₂.

Further, in implementation of reading the first data source and the second data source, data input, for example, is implemented by reading a text using a keyboard. The entity quantities of the first data source and the second data source are respectively m₁ and m₂. For example, the first data source is X={x₁, x₂, . . . , xₘ₁}, and the second data source is Y={y₁, y₂, . . . , yₘ₂}. After the first data source and the second data source are read, the m₁×m₁ kernel matrix K is calculated on the first data source, where the (i, j)^{th} element Kᵢⱼ in the kernel matrix K indicates similarity between xᵢ and xⱼ in reproducing kernel Hilbert space. Likewise, the m₂×m₂ kernel matrix L is calculated on the second data source.

The first processing module 12 is configured to solve a first optimization objective function to obtain a matrix M of a correspondence between an entity on the first data source and an entity on the second data source, where the first optimization objective function is as follows:

$${min}_{M} \vert \vert {KM}^{T} - {( LM )}^{T} {\vert \vert}^{2} \\ s . t {M}_{ij} ∈ \{ 0 , 1 ) ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) .$$

The matrix M is an m₂×m₁ matrix, Mᵢⱼ=1 indicates that the j^{th} entity on the first data source matches the i^{th} entity on the second data source, and Mᵢⱼ=0 indicates that the j^{th} entity on the first data source does not match the i^{th} entity on the second data source. It should be noted that the kernel matrices K and L have already been standardized using K=EKE and L=ELE, where E=I−1/m. A problem to be solved is a binary integer programming problem when the variable Mᵢⱼ is defined as 0 or 1, and a process of solving the first optimization objective function may be, for example, implemented using a branch and bound method, but solving based on this method is time-consuming.

To implement soft matching and simplify the foregoing optimization problem, in this embodiment of the present disclosure, a constraint that each element in the matrix M must be 0 or 1 is changed to Mᵢⱼ≧0, and therefore, the first optimization objective function is changed to:

$${min}_{M} \vert \vert {KM}^{T} - {( LM )}^{T} {\vert \vert}^{2} \\ s . t {M}_{ij} \geq 0 ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) .$$

That the first processing module 12 solves the first optimization objective function further includes solving the first optimization objective function using a convex optimization software package.

The outputting module 13 is configured to output the obtained matrix M.

Furthermore, there are two implementation manners of outputting the obtained matrix M by the outputting module 13. One manner may be sorting values of entities in each column of the matrix M in descending order, and outputting N entities with a maximum Mᵢⱼ value in each column. The other manner is setting a value corresponding to a maximum value in each column of the matrix M to 1, setting a value corresponding to another value except the maximum value in each column to 0, and outputting a matching result.

The apparatus in this embodiment may be configured to execute the technical solution of the method embodiment shown in FIG. 1. The implementation principle thereof is similar, and is not repeated herein.

In the entity matching apparatus provided in this embodiment, after a first data source and a second data source with inconsistent entity quantities are read, a calculating module respectively calculates kernel matrices K and L. Then a first processing module solves a first optimization objective function to obtain a matrix M of a correspondence between an entity on the first data source and an entity on the second data source, and finally an outputting module outputs the obtained matrix M. Therefore, entity matching when entity quantities of data sources are inconsistent can be performed such that accuracy of data mining can be effectively improved, and data value can be effectively presented.

In processing of an actual problem, generally, there may be a small part of annotated data, that is, a one-to-one correspondence between a small part of entities on two data sources is known, and this small part of annotation information is quite valuable. However, this small part of annotation information cannot be used in a conventional entity matching method. An embodiment of the present disclosure provides an entity matching apparatus, which can effectively use precious sample annotation information to improve accuracy of entity matching.

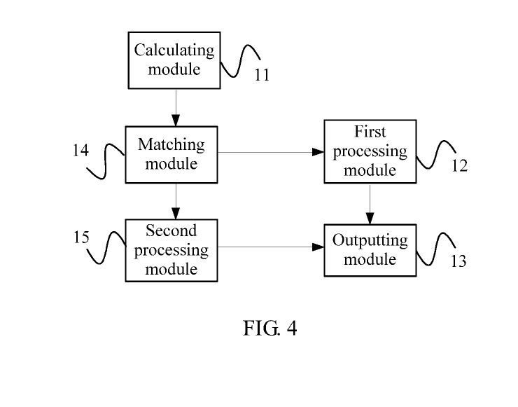

FIG. 4 is a schematic structural diagram of Embodiment 2 of an entity matching apparatus according to the present disclosure. As shown in FIG. 4, on a basis of the apparatus shown in FIG. 3, the apparatus in this embodiment may further include a matching module 14 and a second processing module 15. The matching module 14 is configured to perform entity matching between the entity on the first data source and the entity on the second data source according to unique identifiers of the entities before the first processing module solves the first optimization objective function. The first processing module 12 solves the first optimization objective function when there is no matched entity. The second processing module 15 is configured to use the existent matched entities to form an m₂×m₁ matrix A when there are matched entities, where Aᵢⱼ=1 when the j^{th} entity on the first data source matches the i^{th} entity on the second data source, and Aᵢⱼ=0 when the j^{th} entity on the first data source does not match the i^{th} entity on the second data source, and solve a second optimization objective function to obtain the matrix M of the correspondence between the entity on the first data source and the entity on the second data source, where the second optimization objective function is as follows:

$${min}_{M} \vert \vert {KM}^{T} - {( LM )}^{T} {\vert \vert}^{2} + λ \vert \vert MH - A {\vert \vert}^{2} \\ s . t {M}_{ij} ∈ \{ 0 , 1 ) ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) .$$

H is an m₁×m₁ matrix, and Hᵢᵢ=1 when the i^{th} entity on the first data source is an entity that may be matched according to the unique identifier, or Hᵢᵢ=0 when the i^{th} entity on the first data source is not an entity that may be matched according to the unique identifier, where λ is a predefined scalar. It should be noted that the kernel matrices K and L have already been standardized using K=EKE and L=ELE, where E=I−1/m. A problem to be solved is a binary integer programming problem when the variable Mᵢⱼ is defined as 0 or 1, and a process of solving the first optimization objective function may be, for example, implemented using a branch and bound method, but solving based on this method is time-consuming.

To implement soft matching and simplify the foregoing optimization problem, in this embodiment of the present disclosure, a constraint that each element in the matrix M must be 0 or 1 is changed to Mᵢⱼ≧0, and therefore, the second optimization objective function is changed to:

$${min}_{M} \vert \vert {KM}^{T} - {( LM )}^{T} {\vert \vert}^{2} + λ \vert \vert MH - A {\vert \vert}^{2} \\ s . t {M}_{ij} \geq 0 ∀ i , j \\ {M}^{T} {1}_{{m}_{2}} \leq {1}_{{m}_{1}} \\ M {1}_{{m}_{1}} \leq {1}_{{m}_{2}} \\ {( {1}_{{m}_{2}} )}^{T} M {1}_{{m}_{1}} = min ( {m}_{1} , {m}_{2} ) .$$

In this case, that the second processing module 15 solves the second optimization objective function is further solving the second optimization objective function using a convex optimization software package.

Likewise, there are two implementation manners of outputting the obtained matrix M by the outputting module 13. One manner may be sorting values of entities in each column of the matrix M in descending order, and outputting N entities with a maximum Mᵢⱼ value in each column. The other manner is setting a value corresponding to a maximum value in each column of the matrix M to 1, setting a value corresponding to another value except the maximum value in each column to 0, and outputting a matching result.

The apparatus in this embodiment may be configured to execute the technical solution of the method embodiment shown in FIG. 2. The implementation principle thereof is similar, and is not repeated herein.

In the entity matching apparatus provided in this embodiment, after a first data source and a second data source with inconsistent entity quantities are read, a calculating module respectively calculates kernel matrices K and L, and then a matching module performs entity matching between an entity on the first data source and an entity on the second data source according to unique identifiers of the entities. A first processing module solves a first optimization objective function to obtain a matrix M of a correspondence between the entity on the first data source and the entity on the second data source when there is no matched entity. A second processing module uses the existent matched entities to form a matrix A when there are matched entities, and solves a second optimization objective function to obtain the matrix M of the correspondence between the entity on the first data source and the entity on the second data source. Finally, an outputting module outputs the obtained matrix M. Therefore, entity matching when entity quantities of data sources are inconsistent can be performed, and precious sample annotation information may also be effectively used to improve accuracy of entity matching such that accuracy of data mining can be effectively improved, and data value can be effectively presented.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes any medium that can store program code, such as a read-only memory (ROM), a random access memory (RAM), a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. An entity matching method, comprising:
calculating an m₁×m₁ kernel matrix K on a first data source after reading the first data source;
calculating an m₂×m₂ kernel matrix L on a second data source after reading the second data source, wherein entity quantities of the first data source and the second data source are respectively m₁ and m₂;
solving a first optimization objective function to obtain a matrix M of a correspondence between an entity on the first data source and an entity on the second data source, wherein the first optimization objective function is
$${min}_{M} \vert \vert {KM}^{T} - {( LM )}^{T} {\vert \vert}^{2} s . t {M}_{ij} ∈ \{ 0 , 1 ) ∀ i , j , {M}^{T} {1}_{{m}_{2}} \leq {1}_{{m}_{1}} , M {1}_{{m}_{1}} \leq {1}_{{m}_{2}} , {and ( {1}_{{m}_{2}} )}^{T} M {1}_{{m}_{1}} = min ( {m}_{1} , {m}_{2} ) ,$$
wherein the matrix M is an m₂×m₁ matrix, wherein the Mᵢⱼ=1 indicates that a j^{th} entity on the first data source matches an i^{th} entity on the second data source, and wherein the Mᵢⱼ=0 indicates that the j^{th} entity on the first data source does not match the i^{th} entity on the second data source; and
outputting the obtained matrix M.

2. The method according to claim 1, wherein the first optimization objective function is
$${min}_{M} \vert \vert {KM}^{T} - {( LM )}^{T} {\vert \vert}^{2} s . t {M}_{ij} \geq 0 ∀ i , j , {M}^{T} {1}_{{m}_{2}} \leq {1}_{{m}_{1}} , M {1}_{{m}_{1}} \leq {1}_{{m}_{2}} , {and ( {1}_{{m}_{2}} )}^{T} M {1}_{{m}_{1}} = min ( {m}_{1} , {m}_{2} ) ,$$
and wherein solving the first optimization objective function comprises solving the first optimization objective function using a convex optimization software package.

3. The method according to claim 1, wherein before solving the first optimization objective function, the method further comprises:
performing entity matching between the entity on the first data source and the entity on the second data source according to unique identifiers of the entities;
solving the first optimization objective function when there is no matched entity;
setting the existent matched entities to form an m₂×m₁ matrix A when there are matched entities, wherein Aᵢⱼ=1 when the j^{th} entity on the first data source matches the i^{th} entity on the second data source, and wherein Aᵢⱼ=0 when the j^{th} entity on the first data source does not match the i^{th} entity on the second data source; and
solving a second optimization objective function to obtain the matrix M of the correspondence between the entity on the first data source and the entity on the second data source, wherein the second optimization objective function is
$${min}_{M} \vert \vert {KM}^{T} - {( LM )}^{T} {\vert \vert}^{2} + λ \vert \vert MH - A {\vert \vert}^{2} s . t {M}_{ij} ∈ \{ 0 , 1 ) ∀ i , j , {M}^{T} {1}_{{m}_{2}} \leq {1}_{{m}_{1}} , M {1}_{{m}_{1}} \leq {1}_{{m}_{2}} , {and ( {1}_{{m}_{2}} )}^{T} M {1}_{{m}_{1}} = min ( {m}_{1} , {m}_{2} ) ,$$
wherein H is an m₁×m₁ matrix, wherein Hᵢᵢ=1 when an i^{th} entity on the first data source is an entity that may be matched according to the unique identifier, wherein Hᵢᵢ=0 when the i^{th} entity on the first data source is not the entity that may be matched according to the unique identifier, and wherein λ is a predefined scalar.

4. The method according to claim 3, wherein the second optimization objective function is
$${min}_{M} \vert \vert {KM}^{T} - {( LM )}^{T} {\vert \vert}^{2} + λ \vert \vert MH - A {\vert \vert}^{2} s . t {M}_{ij} \geq 0 ∀ i , j , {M}^{T} {1}_{{m}_{2}} \leq {1}_{{m}_{1}} , M {1}_{{m}_{1}} \leq {1}_{{m}_{2}} , and {( {1}_{{m}_{2}} )}^{T} M {1}_{{m}_{1}} = min ( {m}_{1} , {m}_{2} ) ,$$
and wherein solving the second optimization objective function comprises solving the second optimization objective function using a convex optimization software package.

5. The method according to claim 1, wherein outputting the obtained matrix M comprises:
sorting values of entities in each column of the matrix M in descending order; and
outputting N entities with a maximum Mᵢⱼ value in each column.

6. The method according to claim 1, wherein outputting the obtained matrix M comprises:
setting a value corresponding to a maximum value in each column of the matrix M to 1;
setting a value corresponding to another value except the maximum value in each column to 0; and
outputting a matching result.

7. An entity matching apparatus, comprising:
a memory; and
a processor coupled to the memory and configured to:
calculate an m₁×m₁ kernel matrix K on a first data source after the first data source is read;
calculate an m₂×m₂ kernel matrix L on a second data source after the second data source is read, wherein entity quantities of the first data source and the second data source are respectively m₁ and m₂;
solve a first optimization objective function to obtain a matrix M of a correspondence between an entity on the first data source and an entity on the second data source, wherein the first optimization objective function is
$${min}_{M} \vert \vert {KM}^{T} - {( LM )}^{T} {\vert \vert}^{2} s . t {M}_{ij} ∈ \{ 0 , 1 ) ∀ i , j , {M}^{T} {1}_{{m}_{2}} \leq {1}_{{m}_{1}} , M {1}_{{m}_{1}} \leq {1}_{{m}_{2}} , {and ( {1}_{{m}_{2}} )}^{T} M {1}_{{m}_{1}} = min ( {m}_{1} , {m}_{2} ) ,$$
and wherein the matrix M is an m₂×m₁ matrix, wherein the Mᵢⱼ=1 indicates that a j^{th} entity on the first data source matches an i^{th} entity on the second data source, and wherein the Mᵢⱼ=0 indicates that the j^{th} entity on the first data source does not match the i^{th} entity on the second data source; and
output the obtained matrix M.

8. The apparatus according to claim 7, wherein the first optimization objective function is
$${min}_{M} \vert \vert {KM}^{T} - {( LM )}^{T} {\vert \vert}^{2} s . t {M}_{ij} \geq 0 ∀ i , j , {M}^{T} {1}_{{m}_{2}} \leq {1}_{{m}_{1}} , M {1}_{{m}_{1}} \leq {1}_{{m}_{2}} , and {( {1}_{{m}_{2}} )}^{T} M {1}_{{m}_{1}} = min ( {m}_{1} , {m}_{2} ) ,$$
and wherein the processor is further configured to solve the first optimization objective function using a convex optimization software package.

9. The apparatus according to claim 7, wherein the processor is further configured to:
perform entity matching between the entity on the first data source and the entity on the second data source according to unique identifiers of the entities before solving the first optimization objective function;
solve the first optimization objective function when there is no matched entity;
set the existent matched entities to form an m₂×m₁ matrix A when there are matched entities, wherein Aᵢⱼ=1 when the j^{th} entity on the first data source matches the i^{th} entity on the second data source, and wherein Aᵢⱼ=0 when the j^{th} entity on the first data source does not match the i^{th} entity on the second data source; and
solve a second optimization objective function to obtain the matrix M of the correspondence between the entity on the first data source and the entity on the second data source, wherein the second optimization objective function is
$${min}_{M} \vert \vert {KM}^{T} - {( LM )}^{T} {\vert \vert}^{2} + λ \vert \vert MH - A {\vert \vert}^{2} s . t {M}_{ij} ∈ \{ 0 , 1 ) ∀ i , j , {M}^{T} {1}_{{m}_{2}} \leq {1}_{{m}_{1}} , M {1}_{{m}_{1}} \leq {1}_{{m}_{2}} , and {( {1}_{{m}_{2}} )}^{T} M {1}_{{m}_{1}} = min ( {m}_{1} , {m}_{2} ) ,$$
wherein H is an m₁×m₁ matrix, wherein Hᵢᵢ=1 when an i^{th} entity on the first data source is an entity that may be matched according to the unique identifier, wherein Hᵢᵢ=0 when the i^{th} entity on the first data source is not the entity that may be matched according to the unique identifier, and wherein λ is a predefined scalar.

10. The apparatus according to claim 9, wherein the second optimization objective function is
$${min}_{M} \vert \vert {KM}^{T} - {( LM )}^{T} {\vert \vert}^{2} + λ \vert \vert MH - A {\vert \vert}^{2} s . t {M}_{ij} \geq 0 ∀ i , j , {M}^{T} {1}_{{m}_{2}} \leq {1}_{{m}_{1}} , M {1}_{{m}_{1}} \leq {1}_{{m}_{2}} , and {( {1}_{{m}_{2}} )}^{T} M {1}_{{m}_{1}} = min ( {m}_{1} , {m}_{2} ) ,$$
and wherein the processor is further configured to solve the second optimization objective function using a convex optimization software package.

11. The apparatus according to claim 7, wherein when outputting the obtained matrix M, the processor is further configured to:
sort values of entities in each column of the matrix M in descending order; and
output N entities with a maximum Mᵢⱼ value in each column.

12. The apparatus according to claim 7, wherein when outputting the obtained matrix M, the processor is further configured to:
set a value corresponding to a maximum value in each column of the matrix M to 1;
set a value corresponding to another value except the maximum value in each column to 0; and
output a matching result.
